(19) United States
(12) Patent Application Publication
(10) Pub. No.: US 2004/0156114 A1
(43) Pub. Date: Aug. 12, 2004

(54) Facial mounting equipped with a lateral device for diffusion of virtual images towards a user's pupil

(76) Inventors: Atika El Sayed, Levallois-Perret (FR); Nicolas Paris, Nanterre (FR)

Correspondence Address: MUSERLIAN AND LUCAS AND MERCANTI, LLP, 475 PARK AVENUE SOUTH, NEW YORK, NY, 10016, US

(21) Appl. No.: 10/750,392

(22) Filed: Dec. 30, 2003

Related U.S. Application Data
(63) Continuation-in-part of application No. 10/336,699, filed on Jan. 3, 2003.

(51) Int. Cl. G02B 27/14

(52) U.S. Cl. 359/630

(57) ABSTRACT

A subject of the invention is a device integrated in a pair of spectacles for the diffusion of virtual images into a user's visual field superposed onto his perception of ambient images of the environment in which he finds himself. This device comprises a display unit (108) of virtual images and an optical system comprising a mirror (109) and a terminal lens (110), which comprise virtual image diffusion means (108,109,110), assembled as a prism and attached in a mobile manner laterally to a facial mounting (101) via a chassis (111) which accommodates them in proximity to one another and which is arranged in a dark chamber. These arrangements are such that the virtual images are diffused biased towards the user's pupil from a lateral zone (103) of the mounting (101), optimizing the use of the light intensity of the display unit (108).

Use for producing a system ensuring the diffusion of virtual images into a user's visual field.

The invention belongs to the field of diffusion of virtual images into a user's visual field via an optical system. Its subject is a device for such diffusion adaptable to a facial mounting, such as for example a spectacles mounting, helmet, or similar.

Devices are known comprising means of diffusion of virtual images which are attached to a facial mounting adapted to be worn by a user, and which combine a screen for displaying these images, originating from a remote production source, and an optical system for resending the virtual images displayed on the screen towards a projection surface. Such devices are commonly arranged in order to convey the virtual images laterally to the facial mounting, and to resend them towards the projection surface via the optical system.

According to a first application remote from the subject-matter of the present invention, Documents US5671037 (OGASAWARA et al.) and WO9208157 (The JOHNS HOPKINS UNIVERSITY), for example, describe such a virtual image diffusion device, the projection surface of which is constituted by a mask completely covering the user's field of vision, in order to display virtual images, substituted for the ambient images of the environment in which he finds himself.

According to a second application close to the subject-matter of the present invention, the device is arranged in order to diffuse virtual images complementary to the ambient images perceived by the user, the virtual and ambient images being superposed in his field of vision. Documents DE19625028 (ANDRICH et al) and WO9923525 (The MICROOPTICAL CORPORATION), for example, describe a pair of spectacles which support such a virtual image diffusion device, the optical system of which, forming part of the means of diffusion of these images, combines a mirror and a lens for projecting towards the user's visual field, images originating from the display screen and reflected by the mirror.

More particularly, according to DE 196 25 028, the projection surface of the virtual images is a display mirror integral with one of the eyeglasses of the facial mounting, which receives the virtual images resent by the optical system.

It will be noted that the position of the mirror, at the front of the user's field of vision, interferes in an unwanted manner with the latter's perception of both the virtual images and the ambient images.

More particularly, also according to WO9923525, it is proposed to project the virtual images directly onto the user's pupil, forming in itself the virtual image projection surface. To this end, the optical system comprises a terminal lens for focussing the virtual images, placed facing the user's pupil. The optical system is mounted so that it is mobile on the facial mounting between retracted and operating positions, in which the optical system is respectively moved away from, and placed in, the user's field of vision. The optical system is more particularly mounted pivoting on a support carried by and in extension of an arm of the facial mounting, so that it can be placed in the operating position parallel to and in front of an eyeglass of the latter.

The advantage procured by WO9923525 with respect to DE19625028 lies in the projection of the virtual images directly towards the user's pupil, and not onto a screen interposed in the field of vision of the ambient images as according to DE1 9625028. However, the frontal arrangement in the operating position of the optical system and its support also causes interference by the latter with both the virtual and ambient perceived by the user, such interference being detrimental to visual comfort.

The object of the present invention is to propose a device for the diffusion of virtual images into a user's visual field, superposed onto his perception of ambient images of the environment in which he finds himself, which optimizes the perception by the user of both virtual and ambient images, and which reduces unwanted visual interference between these images, with a view to increasing visual comfort.

The invention is principally, but not exclusively, characterized by the fact that the Applicant has managed to integrate a whole optical system into a spectacle mounting which means:

increased mechanical stability, and in particular without an attached mobile piece, and therefore the optical module is always in the right position in front of the observer's eye.

ease of adjustment, as controls are simple, direct and integrated, which makes them easy to operate,

a virtual image which is well contrasted, as it is inserted into a black chamber integrated in the mounting,

improved ergonomics and comfort. The system according to the invention behaves like a pair of spectacles and therefore rests on the three natural supports (ears, nose). Thus, the system is very light.

Finally, a real spectacles mounting, with arms which close or fold up in order to allow the product to be folded away in a case which can be placed for example in the pocket of a garment.

The inventive step of the present invention has consisted, in general and with regard to practices adopted in the field, of breaking with prejudices, by restoring a user's frontal field of vision to the natural perception of ambient images. This restoration is obtained from a lateral offset on the mounting of all the means necessary for diffusing virtual images towards the user's pupil, so that they do not constitute a frontal obstacle to his field of vision.

Starting from this step, it is proposed to arrange the mounting of the virtual image diffusion means on the facial mounting so that the user's visual field is altered as little as possible, both by the virtual image diffusion means combining electronic display units and optical units for resending these images, and by the elements carrying these units for attaching them to the mounting. For this purpose, the present invention proposes more particularly assembling and mounting said electronic and optical units together on the same chassis located in a lateral zone of the mounting, as defined for example by a spectacle arm.

This lateral offset of all of the means necessary for diffusing the virtual images allows the user to look straight towards the front of his visual field, in order to clearly perceive not only his natural environment, but also the virtual images which are projected laterally towards his pupil.

Moreover, the assembly on the same lateral chassis of said electronic and optical units, makes it possible to arrange this chassis in a dark chamber inside which these units are confined in proximity to one another. This confinement in a restricted volume of the virtual image diffusion means makes it possible to optimize the quality of the virtual image perceived by the user by making the best use of the light intensity of the display unit, starting from an adaptation by myosis to the user's vision of the light intensity of the image perceived.

In the case in particular of a use of the invention on a spectacles mounting, it will be noted that the virtual image diffusion means are grouped together on an arm of the mounting. The mounting is advantageously provided such that it is sufficiently light for its ergonomics not to require any counterweight. In fact, the final product is thus very light.

Following this step, it is proposed to place said electronic and optical units on the chassis according to a prism, the edges of which are approximately formed by the adjacent edges of these units.

More particularly, and in particular in the case where the electronic display units comprise a display screen and the optical resend units comprise a reflecting mirror and a terminal projection lens, the prism is advantageously arranged so that the screen and the overall plane of the lens together define an approximate right angle, whilst the mirror is approximately inclined at 45° with respect to the screen and the overall plane of the lens.

Consequently, not only are the virtual image diffusion means excluded in the operating position from the frontal direction of the user's field of vision, but also the encumbrance of these means as arranged together is considerably reduced, in order to allow them to be worn laterally on the facial mounting.

Consequently also, such an arrangement of the virtual image diffusion means moreover makes it possible, without however inducing a risk of interference with the ambient images, to mount the chassis carrying said electronic display and optical resend units in a mobile manner on the facial mounting, this mobility being made dependent on a control unit easily accessible to the user, laterally on the mounting on which it is installed. These arrangements are such that the user can, starting from an adjustment of the direction of projection of the virtual images towards the pupil, reduce the impact of the virtual images on the ambient images that he perceives at the same time.

Preferably, the electronic elements essential for the visualization of an object or of a reference piece are situated in an arm (maximum integration), the latter nevertheless folds up like the arm of a standard pair of spectacles. It is known, moreover, that a particular design effort was made in order to ensure that the optical function does not disturb the spectacle function. With this in mind, flexible electronic sheets connect the spectacle arm to the optical system. As a result, the device according to the invention can be perfectly folded up and put away in a small space such as a spectacle case or in a pocket.

Moreover, the optical system can easily have accessories added, and in particular means for adjusting the focal distance equipping the terminal lens, without however also inducing a risk of interference with the ambient images.

Similarly, the display unit is capable of being equipped with means for adjusting the luminosity of the images which it diffuses, however without the addition of these means affecting the user's perception of the ambient and virtual images.

These mobility and adjustment arrangements, taken alone or in combination, constitute general means for adjustment by the user of the definition and legibility of the virtual images which he perceives.

The device proposed by the present invention is a device for diffusing virtual images into a user's visual field, superposed onto his perception of ambient images of the environment in which he finds himself. Said device comprises virtual image diffusion means in relation with a remote image-producing source. Said virtual image diffusion means are attached to a facial mounting, such as the mounting of a pair of spectacles, a helmet or similar, and combine a unit for displaying the virtual images produced, such as a screen or similar, and an optical system for resending towards the user's pupil, virtual images displayed by the display unit. Said optical system comprises at least one mirror reflecting the images displayed by the display unit towards a terminal lens for projection of the reflected images.

According to the present invention, said display unit is oriented across the frontal direction of the user's vision and across a plane orthogonal to this direction. The display unit, the mirror and the terminal lens composing the virtual image diffusion means are attached laterally to the facial mounting, being oriented in relation to each other, in such a manner as to form a prism, the edges of which are approximately defined by their corresponding edges.

These arrangements allow a diffusion biased towards the user's pupil of the virtual images projected by the terminal lens, from a lateral zone of the mounting, in which zone the virtual image diffusion means are assembled.

The display unit, the mirror and the terminal lens are preferably carried together by a chassis attached to the mounting via means of mobility. These arrangements are such that the mounting is advantageously equipped with means for adjusting the position of the image projected towards the user's pupil, from a displacement of the whole assembly composing the virtual image diffusion means.

The chassis is preferentially arranged in a dark chamber inside which are attached, in particular by interlocking, the display unit, the mirror and the terminal lens, such that the chassis is arranged in a dark chamber inside which are assembled, in proximity to one another, the units composing the virtual image diffusion means. The presence of a dark chamber has the advantage chiefly of providing enhanced contrast of the virtual image, which is not the case with the type of systems described in Patent WO 99/23525 where the virtual image is distinctly less visible due to the fact that this image is taken to the end of a prism which is open to the air.

More particularly the chassis's envelope conforms to the virtual image diffusion means, one of the side walls of which is formed by the terminal lens and another wall of which is formed by the display unit, in order to allow access to its rear surface, with a view to connecting it to the remote image-producing source, optionally via electronic proximity units, advantageously supported by the mounting.

The means of mobility of the chassis on the facial mounting advantageously comprise a control arm arranged as a telescopic unit, on which telescopic control arm the chassis is mounted in a pivoting manner. The chassis is moreover mounted in a pivoting manner on the mounting, such that the means for adjusting the position of the image projected towards the user's pupil are constituted by the telescopic control arm of the chassis, and by the guide pivoting the chassis on the mounting.

Preferably, the telescopic control arm is principally constituted by a toothed wheel mounted in a turning manner on the facial mounting and by a finger circulating in translation inside the toothed wheel by screwing, the finger being a carrier of the chassis, pivoting at its terminal end.

It will be noted that overall, the means of guiding the chassis on the mounting advantageously combine a cage for receiving the toothed wheel and the hinge pin or similar of the chassis on the mounting, even in substitution or in addition, a cam for guiding the chassis by sliding off-centre with respect to the pivot pin of the chassis on the telescopic control arm.

The virtual image diffusion device is preferentially attached to the mounting via a support unit which it comprises, in order to carry together the chassis and its means of mobility, even if appropriate said electronic proximity means interposed between the display unit and the remote virtual-image producing source. This support unit is equipped with means of connection, by interlinking in particular, on the lateral zone of the mounting, and is preferentially arranged in a case advantageously arranged in two half-shells respectively lower and upper, assembled together by interlocking, in order to envelope the chassis carrying the virtual image diffusion means and its means of mobility.

An access window is preferentially made through the case in order to allow the toothed wheel to emerge from the latter, with a view to its control by the user.

It will be noted that the arrangement of the case is such that the access window is advantageously constituted by an opening made through the wall of the cage for reception of the toothed wheel, and that the hinge pin of the chassis on the mounting is advantageously constituted by a pair of pins, lower and upper, with which the dark chamber constituting the chassis is provided, which cooperate with complementary recesses made in the case, in particular respectively on one and the other of the shells which compose it. If appropriate, the guide cam is advantageously constituted by a column interlocking the half-shells of the housing.

According to an embodiment in which the mounting is a pair of spectacles, the means for connecting the case with the mounting are advantageously constituted by a lateral opening, made in one of the spectacle eyeglasses, in order to receive by sliding interlocking the case, itself provided with slides for receiving the lower and upper edges of the opening.

The optical system according to the invention is compact and integrated into a pair of spectacles, thus forming an inseparable and indissociable assembly, which allows the wearer of these spectacles to visualize and acquire various information which will be displayed in his field of vision. This pair of spectacles can moreover retain its own functions, of correction or protection. To this bi-directional visual function is added the audio system which also allows him to receive and acquire information. The optical system which conveys the image can also be integrated into a variety of different supports: masks, helmets, telescopes in order to allow the user to benefit from a virtual image floating in his field of vision.

The present invention therefore uses the “see-around” system in which the transmitted image will be placed on a more or less significant part of the field of vision.

This system is extremely simple and can be utilized immediately with regard to the uses envisaged and the technology currently available.

The principle of the invention therefore consists of providing the user with the benefit these “see-around” systems by overcoming the current limitations of the existing systems: encumbrance, weight, ergonomics, aesthetics, by integration with the most suitable support, and that best tolerated by the user: namely a pair of spectacles.

The invention can be defined more precisely by the methods of implementation currently preferred.

The invention comprises:

a system allowing the presentation of pairs of spectacles which can be of varying shapes and sizes,

a system allowing the visualization of information in the visual field of the user via a miniaturized screen and an optical system resending an image towards the user's eye, thus creating the illusion of a virtual screen floating in the user's field of vision,

the visualization system can be monocular or binocular and thus does not notably obstruct the user's field of vision.

it also comprises an optoelectronic system forming an integral part of the spectacle structure,

a reversible system in order to be able to be positioned on the right or on the left of the mounting,

a system making it possible to obtain, moreover, auditory information by means of a system of earphones,

a system allowing recording of acoustic information by means of a microphone,

a system allowing recording of visual information by means of a micro camera,

a system allowing the user of position the virtual screen in several places in his field of vision on the horizontal and vertical and depth planes

a system allowing the use of the spectacles for their standard functions, namely correction of vision, visual protection (sun, dust etc.),

a system which must be connected to a central unit in order to receive information. This central unit can take several forms: all types of computer (office computers, portable computers, wearable personal computers, personal digital assistants etc.), video apparatus (television, video cassette recorder, DVDs, cameras, multimedia apparatus etc.), photographic, recording equipment etc.

This central unit can be located at a fixed place or be carried by the user (in a rucksack, on a belt or integrated into a garment).

Finally, it is a system which is intended to be autonomous, operating on its own sources of energy such as a chemical battery or a solar battery.

Conveniently, the optical system according to the invention is chiefly constituted by an optical path integrated into the structure of the spectacles making it possible to receive a light transmission from an image source and to convey it to the user's eye, this optical system being constituted by:

lenses, and

a mirror in prism conformation serving to redirect the light signal emitted by the source towards the user's eye.

The optical path serves to convey the signal towards the optical systems; the optical systems serve to magnify the signal, to correct it and direct it towards the user's pupil; the visual source comprises a flat liquid crystal screen or any available screen using another technology; the visual source is composed of a backlighting module making it possible to generate a light source (in the case of an LCD screen). This visual source is coupled to an electronic system making it possible to generate the display of information on the screen and the backlighting of the latter. The optical system according to the invention is also constituted by a system allowing the diffusion of acoustic information, via a speaker intended to be worn in or close to the ear; the visual source can be adjusted on the focal plane via a device causing one of the prisms to be displaced with respect to the rest of the system which remains fixed.

The optical system according to the invention is also constituted by a system allowing the recording of acoustic information (microphone), a system allowing the recording of visual information thanks to a micro camera situated on the arm opposite the optical system, sound recording and/or reproduction systems which can be integrated into the spectacles or which can also optionally be added to the spectacles mounting. The optical assembly, the visual source and all or part of the associated electronics are accommodated in one of the arms of the spectacles, completely independently of the face of the latter, the electronic modules integrated in the arm of the spectacles are connected to complementary electronic modules, or to the information source, by wire or wireless route. The assembly is then constituted by a case integrating electronic modules (signal conversion, signal processing) connected to the pair of spectacles by wire or wireless route. This module can integrate the display adjustment controls (brightness, contrast and other adjustments). These adjustments can also be offset. The case can also be connected to the spectacles by a wireless system allowing the exchange of information between the electronic elements fixed onto the spectacles and the electronic elements of the case. Moreover, the case can contain an autonomous power supply device serving to generate the energy necessary for the operation of the electronic components which it contains, and those of the spectacles. The visualization system is fixed onto part of the user's head by its integration into a pair of spectacles. The latter comprises:

a facial mounting intended to be held on the user's face,

one or more screens which can provide correction of vision and/or solar protection,

arms, fitted to the mounting and resting on the user's ears, at least one of these arms incorporating the optical system described as well as all or part of the electronic module by means of a housing developed for this purpose; this housing is provided with a mobile system ensuring widthwise, heightwise and depthwise displacement in order to allow adjustment of the optical system and light source with respect to the user's eye.

The assembly thus constituted allows the user to visualize information coming from an external source according to an identified mode:

a screen floating before his eyes (right or left or both) situated starting 15° from the outer field of vision (from the pupil) which can be displaced up to 30 to 40° in order to respect the useful field of vision (which serves as the “working” zone of vision and a “normal” rotation of the eye (0 to 15°),

the device can also be adjusted on the vertical plane in a field 15° above and below the eye's field of vision,

elevation and azimuth adjustment of the display device can be carried out (in the vertical and horizontal planes) well as depth adjustment.

The system according to the invention can be used in an environment intended for professionals and for the general public.

1-Fields of application

industrial (industrial process, quality control, logistics, maintenance),

medical imaging,

automotive,

security,

Navy,

Museums,

exhibitions

General Public

assistance for those with motor disabilities

2-Uses

Reception of Information:

text display: procedures, commands, messaging, address books, information on work, SMS, meetings, tasks, agendas,

displays of diagrams: control plans, graphic diagrams, technical reference systems, road maps,

display of images: medical images, photos, books, tables, Internet, online commands, information retrieval, television,

video displays: Webcams, films, replication of displays from several cameras, face recognition, GPS, video conferencing.

Information Input:

voice recognition: validation of procedures, voice commands: trackball, keyboard,

barcode reader: validation of texts, menus, packages, delivery, commands, selection by text or navigation of pull-down menus,

video: recording of what a person is visualizing by means of the camera intended for the security of a building, a holiday resort, a house, a theatrical production,

audio: recording of what a person is hearing or the sound he is making, by means of the microphone, in order to store information such as a telephone number, a piece of music, sounds.

The present invention will be better understood, and relevant details will appear, with reference to the description to be made of a preferred embodiment, in relation to the figures in the attached pages in which:

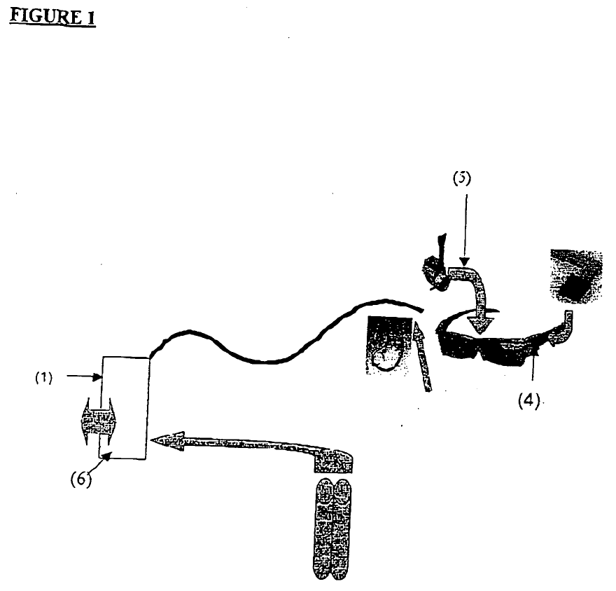

FIG. 1 is a general diagram of a device of the present invention, illustrating its principal components.

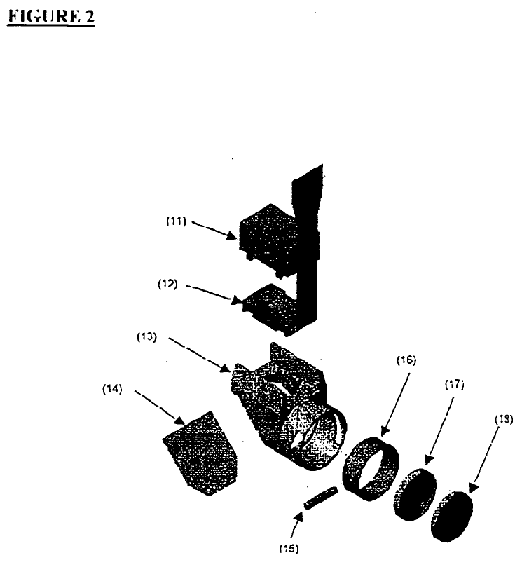

FIG. 2 is an exploded view of an optoelectronic system of a display module carried by a pair of spectacles.

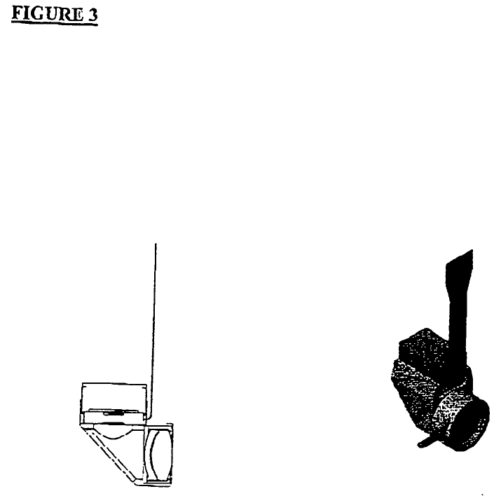

FIG. 3 diagrammatically illustrates the optoelectronic system of the invention and its arrangement on or in a case.

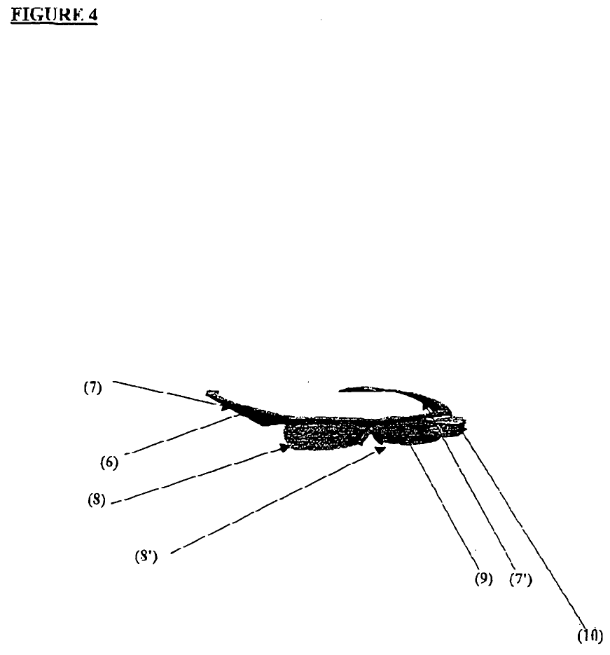

FIG. 4 illustrates a device of the invention carried by a pair of spectacles.

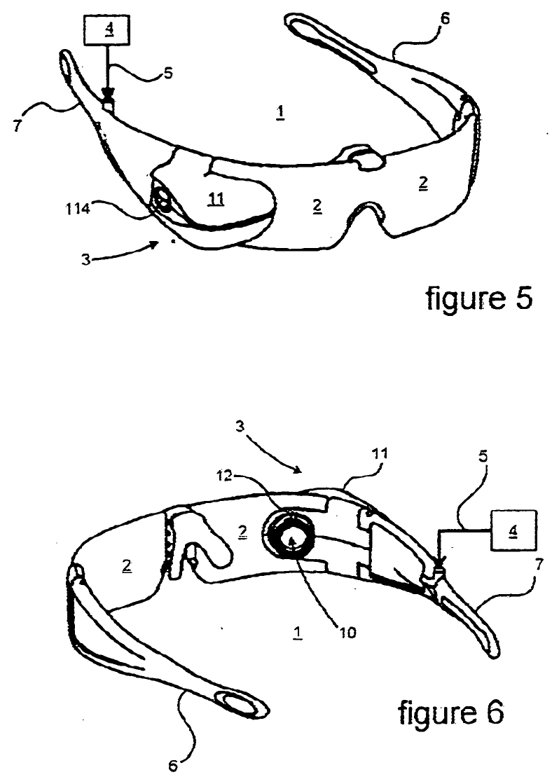

FIG. 5 and FIG. 6 are perspective illustrations of a facial mounting according to the present invention, seen from the front and from the rear respectively.

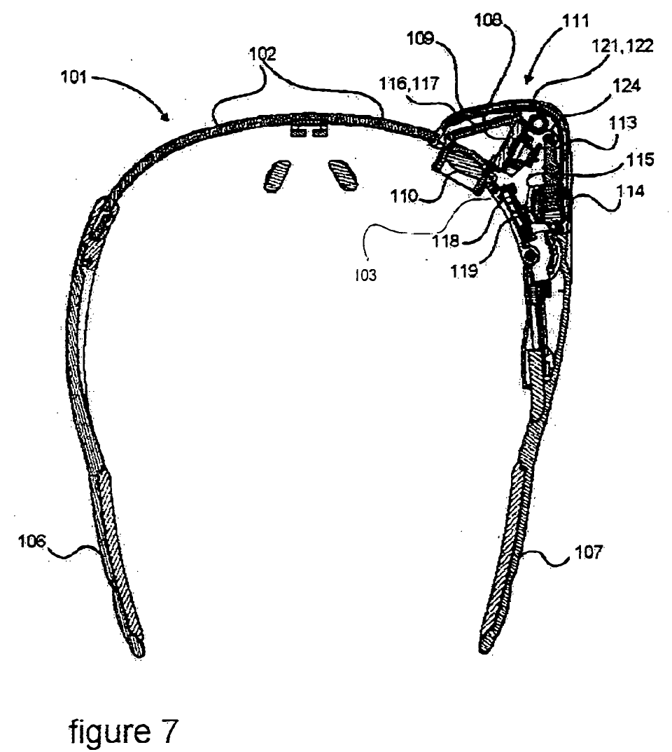

FIG. 7 is a cross-section illustration through a section of the facial mounting represented in FIG. 1.

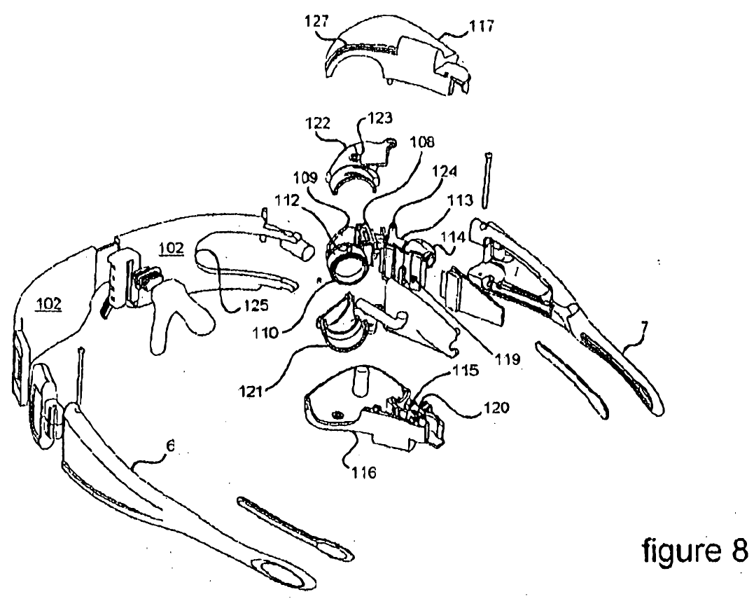

FIG. 8 is an exploded perspective illustration of the facial mounting represented in the preceding figures.

In FIG. 1, a device of the invention comprises information exchange connectors (1) with external systems (not shown), a connection, a microphone/earphone (2), a micro camera (3), a pair of spectacles (4) comprising the display module (5).

The connectors are arranged in a case (6), supplied by an energy source (battery or batteries).

In FIG. 2, the optoelectronic system of the display module carried by a spectacle arm comprises a light source (11), a micro display (12), the main housing (13) and a retractable mirror (14), a sleeve (15) for adjusting the focussing, a cell for lenses (16), spherical lenses (18) and aspherical lenses (17).

FIG. 3 shows diagrammatically the opto-electronic system of the invention and its arrangement in the optical module.

In FIG. 4, the device according to the invention comprises a pair of spectacles, the electronic device and the micro camera mounted on the outer rims of the spectacles. Thus the user can perceive the real image and the image which is transmitted to him without deformation and without delay in transmission. By integrating the micro camera, the user can also film what he is seeing. This figure also shows the pair of spectacles (6) comprising two curved, slightly flattened arms (7) (7′), two glasses for natural vision (8) (8′) and on one of the glasses fixed on the edge of the transversal mounting (9) the electronics case (10).

In FIGS. 5 to 8, a facial mounting of the embodiment illustrated is constituted by a pair of spectacles (101) which allows a user to perceive, in superposition, ambient images of the environment in which he finds himself, and virtual images originating from a remote source (104) producing the latter. The ambient images are perceived by the user through the eyeglasses (102) equipping the spectacles (101) and overall according to the natural frontal direction of vision D. The virtual images are themselves conveyed to a lateral zone (103) of the spectacles (101), from the image source (104) via a cable (105) or similar connected to the virtual image diffusion means (108,109,110). These means (108,109,110) are attached at the lateral zone (103) of the mounting (101) for biased diffusion of virtual images directly towards the user's pupil.

According to one embodiment, not represented, the two arms (106,107) of the pair of spectacles (101) are each capable of receiving the virtual image diffusion means (108,109,110), for example in the case where three-dimensional perception of these images is sought. Such an arrangement procures balanced wearing of the mounting by the user in the case where the virtual image diffusion means are fixed onto only one of the arms of the mounting, without a counterweight, the ergonomics of the mounting being produced such that it requires no counterweight.

These means (108,109,110) principally include a display screen (108) of the virtual images originating from the image source (104), a mirror (109) reflecting the images displayed on the screen (108) and a terminal lens (110) for projecting the reflected images towards the user's pupil. The screen (108), the mirror (109) and the lens (110) form an assembly arranged in a prism, the screen (108) and the overall plane of the lens (110) together defining an approximate right angle, whilst the mirror (109) is approximately inclined at 45° with respect to the screen (108) and the overall plane of the lens (110). This prism arrangement of the screen (108), mirror (109) and lens (110) makes it possible to arrange the virtual image diffusion means in a set of assembled units which allows it to be easily positioned in the lateral zone (103) of the facial mounting (101), and which makes it possible to take advantage of their proximity in order to arrange their confinement inside a dark chamber (111) optimizing the use of the light intensity of the display screen (108).

This dark chamber (111) is composed of two half-shells (121) and (122) fitted together by interlocking, which between themselves accommodate the display screen (108), mirror (109) and lens (110.) It will be noted that the dark chamber (111) comprises clearances to allow respectively the lateral emergence of the lens (110), and access to the rear surface of the display screen (108) with a view to its connection to the remote image-producing source (104), via an interposed electronic proximity circuit (118).

The dark chamber (111) is mounted in a pivoting manner (124) on one of the ends of a finger (113) the other end of which revolves by screwing inside a toothed wheel (114). The latter toothed wheel (114) is mounted in a turning manner in a reception cage (115) forming part of a protective case comprising two half-shells (116,117) assembled together by interlocking, which envelope the dark chamber (111) accommodating the virtual image diffusion means (108,109,110), its means of mobility (113,114) and the electronic proximity circuit (118). It will be noted at this stage of the description that this electronic proximity circuit (118) is supported by the case (116,117) at the rear of the dark chamber (111) and inside a housing (119) provided in the case (116,117), into which it is introduced into by sliding interlocking, and that the toothed wheel (114) can be operated by the user through an access window (120) arranged in the protective case (116,117).

The dark chamber (111) is mounted in a pivoting manner inside the case (116,117) via pins (123) with which its respective shells (121 and 122) are provided, which cooperate with housings provided in the corresponding shells (116 and 117) of the case.

An action on the toothed wheel (114) by the user causes a displacement of the finger (113) inside the toothed wheel (114), which itself causes a pivoting of the dark chamber (111) about its pivot pins (123 and 124), respectively on the case (116,117) and on the finger (113). As the dark chamber (111) carries the lens (110) for projecting the virtual images, the orientation of this projection lens (110) is consequently modified starting from a corresponding operation carried out by the user on the toothed wheel (114), in order to diffuse the virtual images towards the pupil, according to a variably biased orientation freely chosen by the user, within a range of variation in particular comprised between 10° and 20°.

With reference to the embodiment illustrated in which the mounting equipped with the device of the invention is a pair of spectacles, the case (116,117) is assembled on this mounting by interlocking, sliding inside a lateral opening 125 made in one of the spectacle eyeglasses (102). More particularly, the shells (116,117) forming the case each comprise a respective slide (127) for receiving the edges of the opening (125) of the eyeglass (102).

It will be noted that the lens (110) is equipped with a ring (12) for adjusting its focal length in order to facilitate the focussing of the virtual images which it projects towards the user's pupil.

1) Device for the diffusion of virtual images into a user's visual field, superposed onto his perception of ambient images of the environment in which he finds himself, said device comprising virtual image diffusion means (108,109,110) in relation to a remote image-producing source (104), said virtual image diffusion means (108,109,110) being attached to a facial mounting (101) and combining a unit (108) for displaying the virtual images produced and an optical system (109,110) for resending towards the user's pupil, virtual images displayed by the display unit (108), said optical system (109,110) comprising at least one mirror (109) reflecting the virtual images displayed by the display unit (108) towards a terminal lens (110) for projecting the reflected images, the whole assembly achieving complete integration in a spectacle mounting
characterized in that
said display unit (108) is oriented transversally to the frontal direction D of the user's vision and transversally to a plane orthogonal to this direction D, the display unit (108), mirror (109) and terminal lens (110) composing the virtual image diffusion means (108,109,110) being attached laterally to the facial mounting (101) whilst being oriented in relation to each other in order to former a prism, the edges of which are approximately defined by their corresponding edges, in order to allow a biased diffusion towards the user's pupil of the virtual images projected by the terminal lens (110), from a lateral zone (103) of the mounting (101), in which zone (103) the virtual image diffusion means (108,109,110) are assembled.

2) Device according to claim 1,
characterized in that
the display unit (108), the mirror (109) and the terminal lens (110) are together carried by a chassis (111) attached to the mounting (101) via means of mobility, such that the mounting (101) is equipped with means for adjusting the position of the image projected towards the user's pupil,
starting from a displacement of the whole assembly composing the virtual image diffusion means (108,109,110).

3) Device according to claim 2,
characterized in that
the chassis (111) is arranged in an envelope (121,122) inside which the display unit (108), the mirror (109) and the terminal lens (110) are attached, such that the chassis (111) is arranged in a dark chamber inside which the units (108,109,110) composing the virtual image diffusion means are assembled in proximity to one another.

4) Device according to claim 3,
characterized in that
the dark chamber (111) is composed of two half-shells (121,122) joined together by interlocking, and which accommodate between them the display unit (108), mirror (109) and lens (110), the whole forming a dark chamber (111) comprising clearances in order to allow respectively the lateral emergence of the lens (110) and access to the rear surface of the display screen (108) with a view to its connection to the remote image-producing source (104).

5) Device according to any one of claims 2 to 4,
characterized in that
the means of mobility of the chassis (111) on the facial mounting comprise a control arm (113,114) arranged as a telescopic unit, on which telescopic control arm (113,114) the chassis (111) is mounted in a pivoting manner (124), the chassis (111) being moreover mounted in a pivoting manner (123) on the mounting such that the means for adjusting the position of the image projected towards the user's pupil are constituted by the telescopic arm (113,114) for control of the chassis (111), and by the pivoting guiding of the chassis (111) on the mounting.

6) Device according to claim 5,
characterized in that
the telescopic control arm (113,114) is principally constituted by a toothed wheel (114) mounted in a turning manner on the facial mounting (101) and by a finger (113) circulating in translation inside the toothed wheel (114) by screwing, the finger (113) carrying the chassis (111) pivoting at its terminal end.

7) Device according to any one of the previous claims,
characterized in that
the terminal lens (110) is equipped with means (112) for adjusting its focal length.

8) Device according to any one of claims 2 to 7,
characterized in that
it comprises a support unit (116,117) shared by the chassis (111) and its means of mobility (113,114), which is equipped with means of connection (125,127) to the lateral zone of the mounting.

9) Device according to claim 8,
characterized in that
the support unit is arranged in a case made of two half-shells (116,117) joined together by interlocking, in order to envelope the chassis (111) carrying the virtual image diffusion means (108,109,110) and its means of mobility (113,114).

10) Device according to claim 9,
characterized in that,
the mounting being a pair of spectacles, the means for connecting the case (116,117) to the mounting are constituted by a lateral opening (125) made in one (102) of the spectacle eyeglasses, in order to receive by sliding interlocking the case (116,117), itself provided with slides (127) for receiving the lower and upper edges of the opening (125).
